(19) United States
(12) Patent Application Publication
(10) Pub. No.: US 2012/0254534 A1
(43) Pub. Date: Oct. 4, 2012

(54) DATA STORAGE DEVICE

(75) Inventor: RONG-DER HUANG, Tu-Cheng (TW)

(73) Assignee: HON HAI PRECISION INDUSTRY CO., LTD., Tu-Cheng (TW)

(21) Appl. No.: 13/094,770

(22) Filed: Apr. 26, 2011

(30) Foreign Application Priority Data
Mar. 31, 2011 (TW) 100111452

(51) Int. Cl. G06F 12/00

(52) U.S. Cl. 711/114; 711/E12.001

(57) ABSTRACT

A data storage device includes a plurality of main hard disk drives (HDD), at least one standby HDD, and a Redundant Array of Independent Disks (RAID) controller. The RAID controller controls all the plurality of main HDDs to form an RAID array that serve as a virtual single hard disk drive for storing data. When any one of the plurality of main HDDs malfunctions, the RAID controller adds the standby HDD to the RAID array to replace the malfunctioning main HDD.

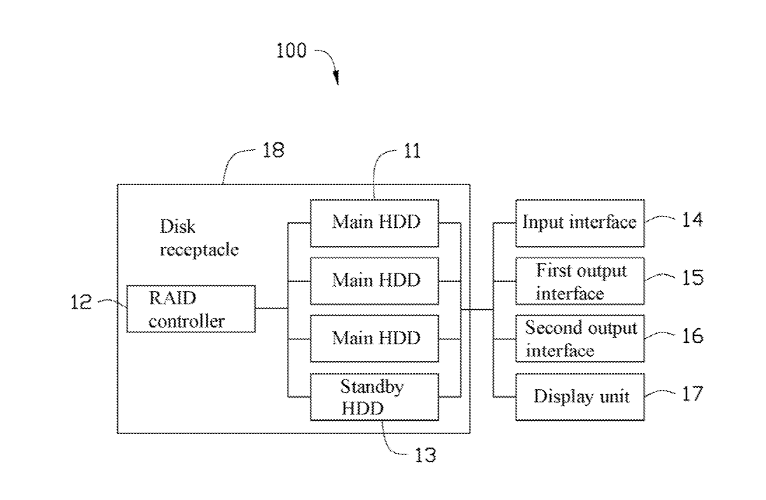

### BACKGROUND

1. Technical Field

The present disclosure relates to data storage devices, and particularly to a multimedia data storage device.

2. Description of Related Art

Mobile storage devices, such as Universal Serial Bus (USB) mass storage devices and mobile hard disks, are widely used. However, most mobile storage devices have less storage space than fixed storage devices. When much data needs to be stored together, like from a project, a mobile storage device may be insufficient.

Therefore, there is room for improvement within the art.

### BRIEF DESCRIPTION OF THE DRAWINGS

Many aspects of the present disclosure can be better understood with reference to the following drawings. The components in the various drawings are not necessarily drawn to scale, the emphasis instead being placed upon clearly illustrating the principles of the present disclosure. Moreover, in the drawings, like reference numerals designate corresponding parts throughout the figures.

The FIGURE is a block diagram of a data storage device, according to an exemplary embodiment.

### DETAILED DESCRIPTION

The figure shows a data storage device 100, according to an exemplary embodiment. The data storage device 100 can be a mobile storage device. In this embodiment, the data storage device 100 includes a plurality of main hard disk drives (HDDs) 11, a Redundant Array of Independent Disks (RAID) controller 12, at least one standby HDD 13, an input interface 14, a first output interface 15, a second output interface 16, a display unit 17, and a disk receptacle 18. In general, the word “unit”, as used herein, refers to logic embodied in hardware or firmware, or to a collection of software instructions, written in a programming language, such as, Java, C, or Assembly. One or more software instructions in the units may be embedded in firmware, such as EPROM. The units described herein may be implemented as either software and/or hardware units and may be stored in any type of computer-readable medium or other storage device.

The main HDDs 11, the RAID controller 12, and the standby HDD 13 are all received in the disk receptacle 18, and the RAID controller 12 is electrically connected to each of the main HDDs 11 and the standby HDD 13. In this embodiment, the data storage device 100 includes at least three main HDDs 11. Each of the main HDDs 11 and the standby HDD 13 can be a storage unit of a common mobile storage device, such as a Universal Serial Bus (USB) mass storage device or a mobile hard disk. Storage space of the standby HDD 13 is not less than storage space of each of the main HDDs 11.

The RAID controller 12 controls all the main HDDs 11 to form an RAID array (not labeled), and determines an array mode of the RAID array. The array mode of the RAID array can be selected from common RAID technology standards, such as RAID0-RAID7, RAID10, RAID50, and RAID53 standards, etc. In this embodiment, the array mode of the RAID array formed with the main HDDs 11 is RAIDS standard. According to RAIDS standard, the RAID array formed by the main HDDs 11 can serve as a virtual single hard disk drive, with storage space being theoretically equal to total storage space of all the main HDDs 11 combined. In this way, the main HDDs 11 can be used to store a great of amount of data, such as from multimedia files.

In use, when any one of the main HDDs 11 malfunctions, the RAID controller 12 temporarily removes the malfunctioning main HDD 11 from the RAID array to facilitate repairing of the malfunctioning main HDD 11, and adds the standby HDD 13 to the RAID array to replace the malfunctioning main HDD 11. Since the storage space of the standby HDD 13 is not less than the storage space of the malfunctioning main HDD 11, the storage space of the RAID array does not decrease. After the malfunctioning main HDD 11 is repaired, the RAID controller 12 can add the repaired main HDD to the RAID array again and return the standby HDD 13 to be an idle state. If the malfunctioning main HDD 11 cannot be repaired, it can be left in place as part of the RAID array and perpetually replaced by the standby HDD 13. An additional standby HDD 13 with storage space not less than the storage space of the former standby HDD 13 can be added to the data storage device 100.

Furthermore, according to RAIDS standard, when the main HDDs 11 are used to form the RAID array, backup and calibration information of data stored in each main HDD 11 can be stored in the other main HDDs 11. When one or more main HDD 11 malfunctions, the RAID controller 12 can easily recover data that was stored in the malfunctioning main HDD 11 according to its backup and/or calibration information stored in the other main HDDs 11.

The input interface 14, the first output interface 15, and the second output interface 16 are all electrically connected to each of the main HDDs 11 and the standby HDD 13. Both the input interface 14 and the first output interface 15 are Universal

Serial Bus (USB) interfaces. The second output interface 16 is a High Definition Multimedia Interface (HDMI), which can be used with many electronic devices supporting multimedia data, such as High Definition Televisions (HDTV), digital sounds, etc. Data can be stored to the data storage device 100 through the input interface 14, and is transmitted to other electronic devices through the first output interface 15 and the second output interface 16. Thus, the data storage device 100 is compatible with both electronic devices using USB interfaces and electronic devices using HDMI interfaces, and multimedia data stored in the data storage device 100 can be directly transmitted to electronic devices supporting multimedia data (e.g., HDTV).

The display unit 17 is also electrically connected to each of the main HDDs 11 and the standby HDD 13. The display unit 17 is used to show current use states of the data storage device 100, for example, current free space of each main HDD 11 and the RAID array formed by all the main HDDs 11, kinds of data stored in the data storage device 100, if any main HDD 11 is busy or malfunctioning, etc. The display unit 17 can be an independent display, and can also be integrated with a display of an electronic device (not shown) communicating with the data storage device 100, such as a personal computer (PC).

In the present disclosure, all the main HDDs 11 cooperatively form the RAID array serving as a virtual single hard disk drive, with storage space being theoretically equal to total storage space of all the main HDDs 11 combined. Thus, the data storage device 100 can store very large files. Furthermore, the data storage device 100 has high compatibility and data recovery function.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A data storage device, comprising:
a plurality of main hard disk drives (HDD);
at least one standby HDD; and
a Redundant Array of Independent Disks (RAID) controller connected to each of the plurality of main HDDs and the standby HDD; wherein the RAID controller controls all the plurality of main HDDs to form an RAID array that serve as a virtual single hard disk drive for storing data; and when any one of the plurality of main HDDs malfunctions, the RAID controller adds the standby HDD to the RAID array to replace the malfunctioning main HDD.

2. The data storage device as claimed in claim 1, wherein the RAID controller controls all the plurality of main HDDs to form the RAID array according to RAIDS standard.

3. The data storage device as claimed in claim 1, wherein storage space of the standby HDD is not less than storage space of each of the plurality of main HDDs.

4. The data storage device as claimed in claim 1, wherein after the malfunctioning main HDD is repaired, the RAID controller adds the repaired main HDD to the RAID array again and reinstates the standby HDD to be idle.

5. The data storage device as claimed in claim 1, wherein when the standby HDD replaces the malfunctioning main HDD, the malfunctioning main HDD is removed, and an additional standby HDD is connected to the RAID controller to replace the standby HDD that replaces the malfunctioning main HDD.

6. The data storage device as claimed in claim 5, wherein storage space of the additional standby HDD is not less than the storage space of the standby HDD that replaces the malfunctioning main HDD.

7. The data storage device as claimed in claim 1, wherein backup and calibration information of data stored in each main HDD is stored in the others of the plurality of main HDDs; when one or more main HDD malfunctions, the RAID controller recovers data that was stored in the malfunctioning main HDD according to its backup and/or calibration information stored in other normal main HDD.

8. The data storage device as claimed in claim 1, further comprising an input interface, a first output interface, and a second output interface, all the input interface, the first output interface, and the second output interface connected to each of the plurality of main HDD and the standby HDD; both the input interface and the first output interface being Universal Serial Bus (USB) interfaces, and the second output interface being a High Definition Multimedia Interface (HDMI).

9. The data storage device as claimed in claim 1, further comprising a display unit connected to each of the plurality of main HDDs and the standby HDD.

10. The data storage device as claimed in claim 1, wherein the data storage device is a mobile storage device.
